(19) United States
(12) Patent Application Publication
(10) Pub. No.: US 2012/0062905 A1
(43) Pub. Date: Mar. 15, 2012

(54) OPTICAL DETECTION SYSTEM AND PROGRAM

(75) Inventor: Kanechika KIYOSE, Matsumoto (JP)

(73) Assignee: SEIKO EPSON CORPORATION, Tokyo (JP)

(21) Appl. No.: 13/225,901

(22) Filed: Sep. 6, 2011

(30) Foreign Application Priority Data
Sep. 13, 2010 (JP) 2010-204017

(51) Int. Cl. G01B 11/14

(52) U.S. Cl. 356/614

(57) ABSTRACT

An optical detection system includes: a detecting section which detects position detection information on an object on the basis of a light reception result of reflection light reflected from the object; and a processing section which performs a process on the basis of the position detection information. The processing section performs at least one command process using X coordinate information and Y coordinate information on the object, in a case where it is detected that a Z coordinate range of the object from a target surface is in a first Z coordinate range, and performs a process for a hovering operation using the X coordinate information and Y coordinate information on the object, in a case where it is detected that the Z coordinate range is in a second Z coordinate range which is distant from the target surface compared with the first Z coordinate range.

### BACKGROUND

1. Technical Field

The present invention relates to an optical detection system, a program, and the like.

2. Related Art

In electronic devices such as a mobile phone, a personal computer, a car navigation device, a ticket machine, and a bank terminal, a display apparatus having a position detection function in which a touch panel is disposed on a front surface of a display section has been recently used. In such a display apparatus, a user can input information while referring to an image displayed on the display section and pointing an icon or the like at the displayed image. For the position detection using such a touch panel, for example, a resistive touch panel, a capacitive touch panel, or the like are known.

On the other hand, in a projection display apparatus (projector) or a display apparatus for digital signage, the display area is wide compared with the display apparatus such as a mobile phone or a personal computer. Thus, it is difficult to realize the position detection using a resistive or capacitive touch panel in such a display apparatus.

As a position detection device for the projection display apparatus in the related art, techniques disclosed in JP-A-11-345085 and JP-A-2001-142643, for example are known. However, in such a position detection device, it is easy to detect a position in a system to suspend a pointer, but it is difficult to switch the suspending function and a fixing function (determining operation) for fixing a point.

In a case where the switch between the suspending function and the fixing function (determining operation) is difficult, for example, in a case where characters are input, it is difficult to discriminate a point for starting the character input (that is, it is difficult to start character writing), and it is difficult to discriminate the end of the character input (that is, all the characters are written in a traversable manner).

### SUMMARY

An advantage of some aspects of the invention is that it provides an optical detection system, a program and the like which can detect position information on an object and switch a command process and a hovering process according to Z coordinate information on the object.

One aspect of the invention is directed to an optical detection system including: a detecting section which detects position detection information on an object on the basis of a light reception result of reflection light obtained by reflecting irradiation light from the object; and a processing section which performs a process on the basis of the position detection information, wherein the processing section performs at least one command process among command determination and command execution using X coordinate information and Y coordinate information on the object, in a case where it is detected that a Z coordinate range of the object from a target surface is in a first Z coordinate range which is close to the target surface, and performs a hovering process which is a process for a hovering operation using the X coordinate information and Y coordinate information on the object, in a case where it is detected that the Z coordinate range of the object from the target surface is in a second Z coordinate range which is distant from the target surface compared with the first Z coordinate range.

With this configuration, the optical detection system can perform the command process in a case where it is detected that the Z coordinate range of the object is in the first Z coordinate range, and can perform the hovering process in a case where it is detected that the Z coordinate range of the object is in the second Z coordinate range. Thus, it is possible to appropriately switch the command process and the hovering process on the basis of the Z coordinate range.

In the optical detection system, the processing section may perform the command process using the X coordinate information and the Y coordinate information on the object, in a case where a movement speed which is expressed by Z directional movement speed information on the object is larger than a predetermined threshold.

With this configuration, it is possible to perform the command process in a case where the movement speed in the Z direction is large.

In the optical detection system, the processing section may perform, in a case where a time period from a time when it is detected that the Z coordinate range of the object from the target surface is in the second Z coordinate range to a time when it is detected that the Z coordinate range of the object from the target surface is in the first Z coordinate range is smaller than a predetermined threshold, the command process using the X coordinate information and the Y coordinate information on the object when it is detected that the Z coordinate range of the object from the target surface is in the first Z coordinate range.

With this configuration, it is possible to determine that the movement speed is large and to perform the command process in a case where the time period from a time when the object is detected in the second Z coordinate range to time when the object is detected in the first Z coordinate range is smaller than the predetermined threshold.

The optical detection system may further include: a light irradiating section which emits the irradiation light; and a light receiving section which includes a first light receiving unit and a second light receiving unit. The light irradiating section may irradiate a detection area which is an area in which the object is detected with the irradiation light. The first light receiving unit may receive first reflection light obtained by reflecting the irradiation light from the object in a first detection area of the detection area, and the second light receiving unit may receive second reflection light obtained by reflecting the irradiation light from the object in a second detection area of the detection area. The detecting section may obtain the X coordinate information and the Y coordinate information on the object in the first detection area on the basis of first position detection information which is a light reception result of the first reflection light, and may obtain the X coordinate information and the Y coordinate information on the object in the second detection area on the basis of second position detection information which is a light reception result of the second reflection light.

With this configuration, the optical detection system, which includes the light irradiation section and the light receiving section, can detect the position information on the object in the first detection area by the first light receiving unit of the light receiving section and can detect the position information on the object in the second detection area by the second light receiving unit of the light receiving section.

In the optical detection system, the first light receiving unit may be disposed in a position close to the target surface in the Z direction compared with the second light receiving unit, and the processing section may perform the command process on the basis of the X coordinate information and the Y coordinate information of the detecting section according to the light reception result of the first light receiving unit and may perform the hovering process on the basis of the X coordinate information and the Y coordinate information of the detecting section according to the light reception result of the second light receiving unit.

With this configuration, it is possible to detect the object in the first Z coordinate range by the first light receiving unit and to detect the object in the second Z coordinate range by the second light receiving unit.

In the optical detection system, the processing section may perform the hovering process in a case where the light reception of the second light receiving unit is detected, and then may perform the command process in a case where the light reception of both of the second light receiving unit and the first light receiving unit is detected.

With this configuration, it is possible to switch the hovering process to the command process corresponding to transition from the light reception of the second light receiving unit to the light reception of both of the first light receiving unit and the second light receiving unit.

In the optical detection system, the processing section may perform, as the command process, at least one process among drawing command determination and drawing command execution on the basis of the X coordinate information and the Y coordinate information on the object.

With this configuration, the optical detection system can perform, as the command process, at least one process among the drawing command determination and the drawing command execution.

In the optical detection system, the processing section may perform, as the hovering process, a process of moving a cursor to a screen position corresponding to the position of the object using the X coordinate information and the Y coordinate information on the object.

With this configuration, the optical detection system can perform the cursor movement process as the hovering process.

In the optical detection system, the processing section may perform, as the hovering process, a process of selecting an icon at a screen position corresponding to the position of the object using the X coordinate information and the Y coordinate information on the object.

With this configuration, the optical detection system can perform the icon selecting process as the hovering process.

Another aspect of the invention is directed to an optical detection system including: a detecting section which detects position detection information on an object on the basis of alight reception result of reflection light obtained by reflecting irradiation light from the object; a processing section which performs a process on the basis of the position detection information; and a light receiving section which includes a first light receiving unit and a second light receiving unit, wherein the first light receiving unit is disposed in a position close to the target surface in the Z direction compared with the second light receiving unit, and wherein the processing section performs the command process on the basis of the X coordinate information and the Y coordinate information of the detecting section according to the light reception result of the first light receiving unit, and performs the hovering process on the basis of the X coordinate information and the Y coordinate information of the detecting section according to the light reception result of the second light receiving unit.

With this configuration, the light receiving section includes two light receiving units, and the processing section can perform the command process on the basis of the light reception result of the first light receiving unit and can perform the hovering process on the basis of the light reception result of the second light receiving unit.

Still another aspect of the invention is directed to a program which causes a computer to execute functions including: a detecting section which detects position detection information on an object on the basis of a light reception result of reflection light obtained by reflecting irradiation light from the object; and a processing section which performs a process on the basis of the position detection information, wherein the processing section performs at least one command process among command determination and command execution using X coordinate information and Y coordinate information on the object, in a case where it is detected that a Z coordinate range of the object from a target surface is in a first Z coordinate range which is close to the target surface, and performs a hovering process which is a process for a hovering operation using the X coordinate information and Y coordinate information on the object, in a case where it is detected that the Z coordinate range of the object from the target surface is in a second Z coordinate range which is distant from the target surface compared with the first Z coordinate range.

Yet another aspect of the invention is directed to a program which causes a computer to execute functions including: a detecting section which detects position detection information on an object on the basis of a light reception result, in a light receiving section, of reflection light obtained by reflecting irradiation light from the object; and a processing section which performs a process on the basis of the position detection information, wherein the light receiving section includes a first light receiving unit and a second light receiving unit, and the first light receiving unit is disposed in a position close to the target surface in the Z direction compared with the second light receiving unit, and wherein the processing section performs the command process on the basis of the X coordinate information and the Y coordinate information of the detecting section according to the light reception result of the first light receiving unit, and performs the hovering process on the basis of the X coordinate information and the Y coordinate information of the detecting section according to the light reception result of the second light receiving unit.

### BRIEF DESCRIPTION OF THE DRAWINGS

The invention will be described with reference to the accompanying drawings, wherein like numbers reference like elements.

FIGS. 1A and 1B illustrate an example of a configuration of an optical detection system according to an embodiment of the invention.

FIG. 2 illustrates an example of a configuration of a light receiving section.

FIG. 3 illustrates another example of a configuration of a light receiving section.

FIGS. 4A and 4B illustrate an example of a configuration of a light receiving unit.

FIG. 5 illustrates an example of a configuration of a light irradiating section.

FIG. 6 is a diagram illustrating movement of an object when a command process and a hovering process are switched with each other.

FIG. 7 is a diagram illustrating the relationship between combination of light reception results and processes to be performed.

FIG. 8 illustrates a setting example of a first Z coordinate range and a second Z coordinate range.

FIG. 9A is a diagram illustrating a cursor movement process, and FIG. 9B is a diagram illustrating an icon selection process.

FIGS. 10A and 10B are diagrams illustrating a method of detecting coordinate information.

FIGS. 11A and 11B are examples of signal waveforms of a light emission control signal.

FIG. 12 illustrates another example of a configuration of a light irradiating section.

FIG. 13 illustrates another example of a configuration of an optical detection apparatus for detecting a Z coordinate.

### DESCRIPTION OF EXEMPLARY EMBODIMENTS

Hereinafter, preferred embodiments of the invention will be described. The embodiments do not unreasonably limit the content of the invention disclosed in the appended claims, and not all configurations described in this embodiment necessarily serve as essential solving means of the invention.

### 1. Configuration Example of Optical Detection System

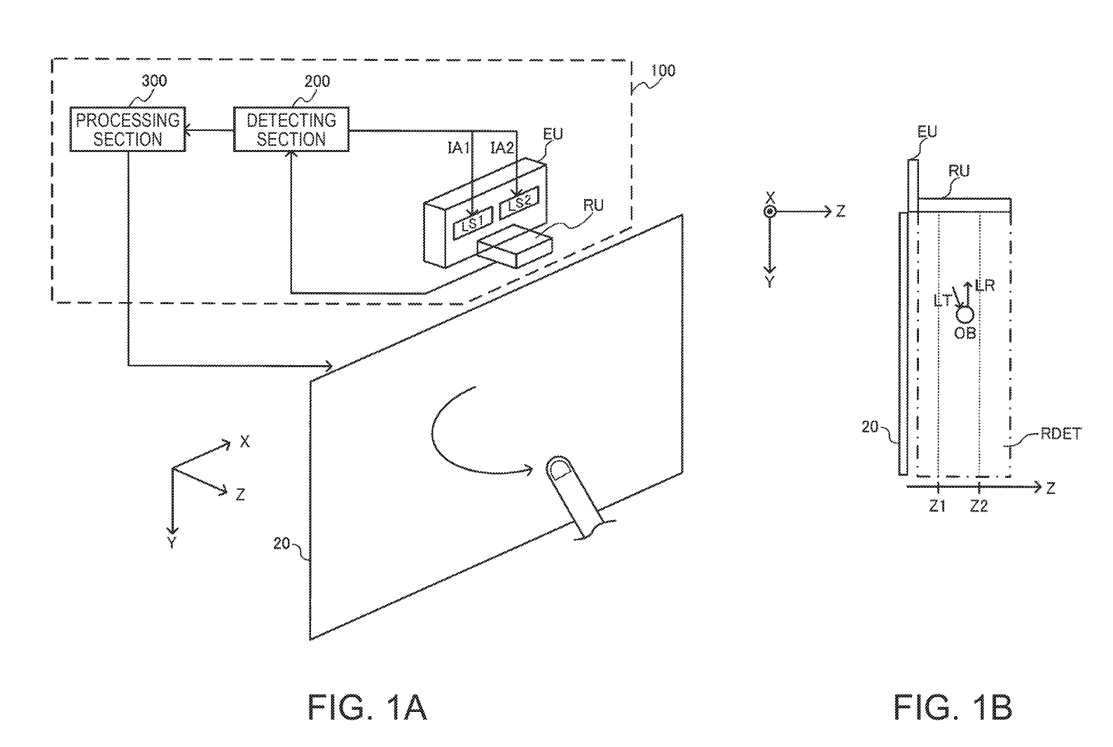

FIG. 1A illustrates an example of a basic configuration of an optical detection system according to the present embodiment which is realized by an optical detection apparatus 100 or the like. The optical detection apparatus 100 in FIG. 1A includes a detecting section 200, a processing section 300, a light irradiating section EU and a light receiving section RU. FIG. 1B is a diagram illustrating detection of Z coordinate information by means of the optical detection system according to this embodiment. The optical detection system in this embodiment is not limited to the configuration shown in FIGS. 1A and 1B, but may employ a variety of modifications such that some of its components are omitted or replaced with different components, or different components may be added.

The optical detection system is not limited to the optical detection apparatus 100 which includes the detecting section 200 and the processing section 300 as described above. Functions of the detecting section 200 and the processing section 300 are realized by an information processing apparatus (for example, PC or the like). The optical detection system may be realized by operating the light irradiating section EU and the light receiving section RU operate in conjunction with the information processing apparatus.

The detecting section 200 detects coordinate information on an object OB on the basis of a light reception result of reflection light LR obtained by reflecting irradiation light LT from the object OB. Specifically, for example, as shown in FIG. 1B, in a case where a detection area RDET which is an area in which the object OB is detected is set in a target surface along an X-Y plane, the detecting section 200 detects at least Z coordinate information which is coordinate information in a Z direction. The detecting section 200 may further detect X coordinate information and Y coordinate information about the object OB which is present in the detection area RDET. A method of detecting the coordinate information by means of the detecting section 200 will be described later.

The detection area RDET is an area (region) in which the object OB is detected, and specifically, for example, is an area where the light receiving section RU can receive the reflection light LR obtained by reflecting the irradiation light LT from the object OB to detect the object OB. More specifically, the area refers to an area where the light receiving section RU can receive the reflection light LR to detect the object OB and the detection accuracy of an allowable range can be secured.

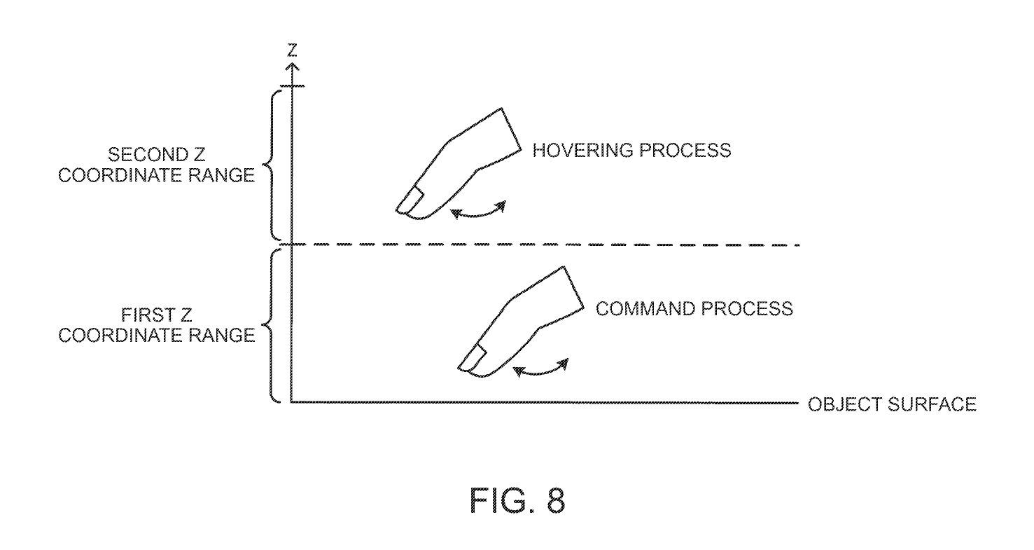

The processing section 300 performs a variety of processes on the basis of the coordinate information detected by the detecting section 200. In particular, the processing section 300 performs switching between a command process (fixing function) and a hovering process (suspending function) on the basis of the Z coordinate information of the object OB. Here, the switching between the command process and the hovering process means, as shown in FIG. 8 described later, that the command process is performed when it is determined that the Z coordinate information on the object OB is in a first Z coordinate range, and the hovering process is performed when it is determined that the Z coordinate information on the object OB is in a second Z coordinate range. Details thereof will be described.

The light irradiating section EU emits the irradiation light LT to the detection area RDET. As described later, the light irradiating section EU includes a light source section including a light emitting element such as an LED (light emitting diode) and emits infrared light (near-infrared light which is near a visible light region) by the light source section.

The light receiving section RU receives the reflection light LR obtained by reflecting the irradiation light LT from the object OB. The light receiving section RU may include a plurality of light receiving units PD. The light receiving units PD may include a photodiode, a phototransistor or the like, for example.

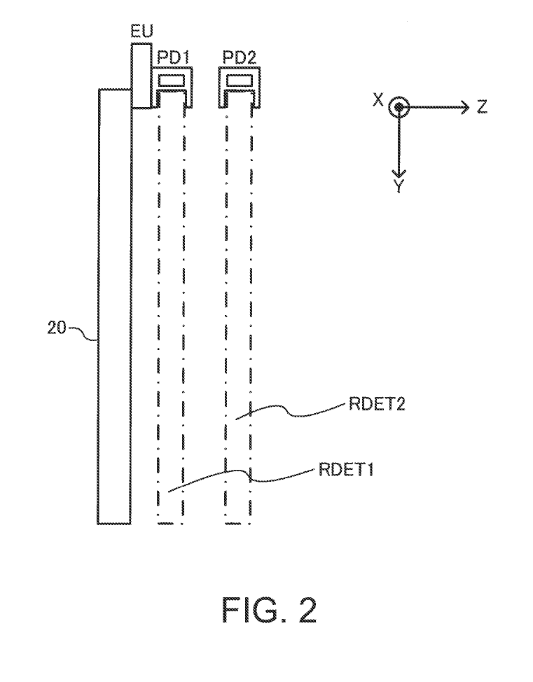

FIG. 2 illustrates a specific configuration example of the light receiving section RU according to this embodiment. In the configuration example in FIG. 2, the light receiving section RU includes two light receiving units PD1 and PD2, and the light receiving units PD1 and PD2 are arranged in positions having different heights. The two light receiving units PD1 and PD2 have a slit (incident light control section) for controlling an angle (angle on a Y-Z plane) at which incident light is input, and receives the reflection light LR from the object OB which is present in detection areas RDET1 and RDET2, respectively. For example, the light receiving unit PD1 receives the reflection light LR from the object OB which is present in the detection area RDET1, but does not receive the reflection light LR from the object OB which is present in the detection area RDET2. The detecting section 200 detects Z coordinate information on the basis of a light reception result of each of the plurality of light receiving units PD1 and PD2. The light irradiating section EU emits the irradiation light LT to the two detection areas RDET1 and RDET2. Further, each of the detection areas RDET1 and RDET2 is an area along the X-Y plane.

In this way, it is possible to detect whether the object OB is present in either detection area of the two detection areas RDET1 and RDET2, and it is thus possible to detect the Z coordinate information on the object OB. Further, as described above, it is possible to perform switching between the command process and the hovering process on the basis of the Z coordinate information.

The configuration example in FIG. 2 includes two light receiving units, but may include three or more light receiving units. Further, as described later, as the light irradiating section EU emits the irradiation light LT and each of the light receiving units PD1 and PD2 receives the reflection light LR from the object OB, it is possible to detect the X coordinate information and the Y coordinate information on the object OB.

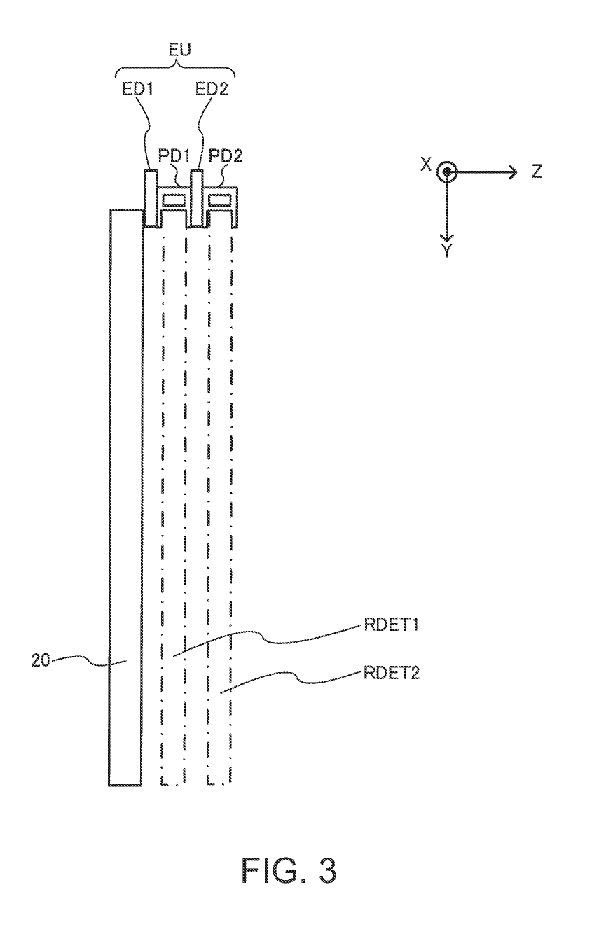

FIG. 3 illustrates a modified example of the light receiving section RU according to this embodiment. In the modified example in FIG. 3, the light irradiating section EU includes two light irradiating units ED1 and ED2. The light irradiating units ED1 and ED2 emit the irradiation light LT to the corresponding detection areas RDET1 and RDET2. For example, when the object OB is present in the detection area RDET1, the irradiation light from the light irradiating unit ED1 is reflected from the object OB, and the reflection light is then received by the light receiving unit PD1.

In this way, it is possible to detect whether the object OB is present in either detection area of the two detection areas RDET1 and RDET2, and it is thus possible to detect the Z coordinate information on the object OB and to perform switching between the command process and the hovering process. Further, as one light irradiating unit is installed to correspond to one detection area, it is possible to improve the detection accuracy of the Z coordinate information.

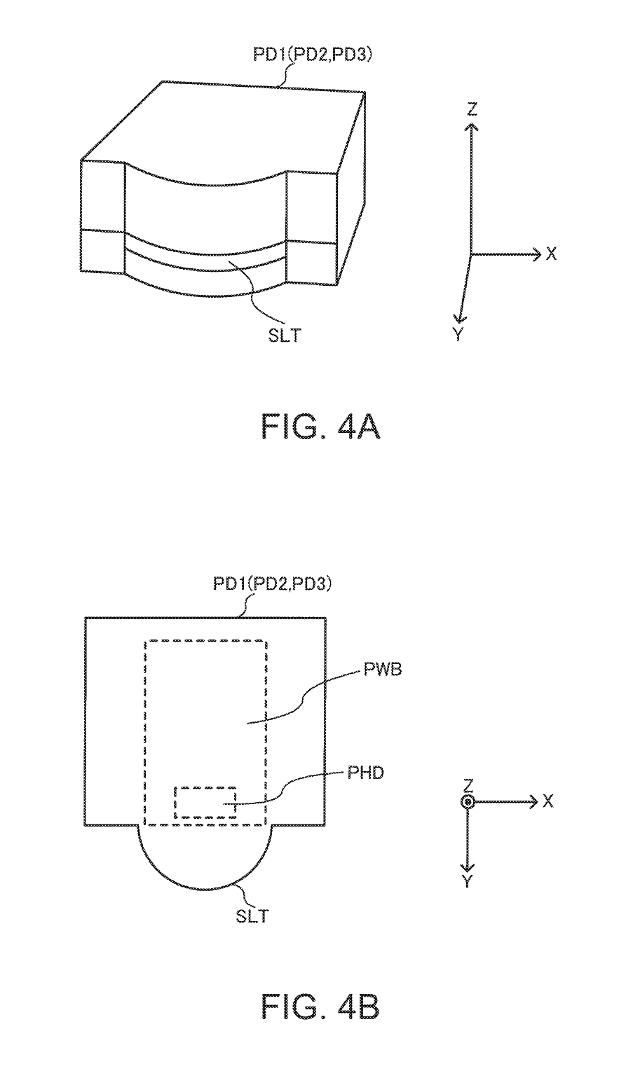

FIGS. 4A and 4B show an example of a configuration of the light receiving units PD1 and PD2 with a slit SLT (incident light control section). As shown in FIG. 4A, the slit SLT is disposed in front of a light receiving element PHD to control incident light. The slit SLT is disposed along the X-Y plane to thereby control an angle of the incident light in a Z direction. That is, the light receiving units PD1 and PD2 can receive the incident light at a predetermined angle defined by a slit width of the slit SLT.

FIG. 4B is a plan view of the light receiving units having the slit SLT, when seen from above. For example, a wiring substrate PWB is disposed in a case made of aluminum or the like, and the light receiving element PHD is mounted on the wiring substrate PWB.

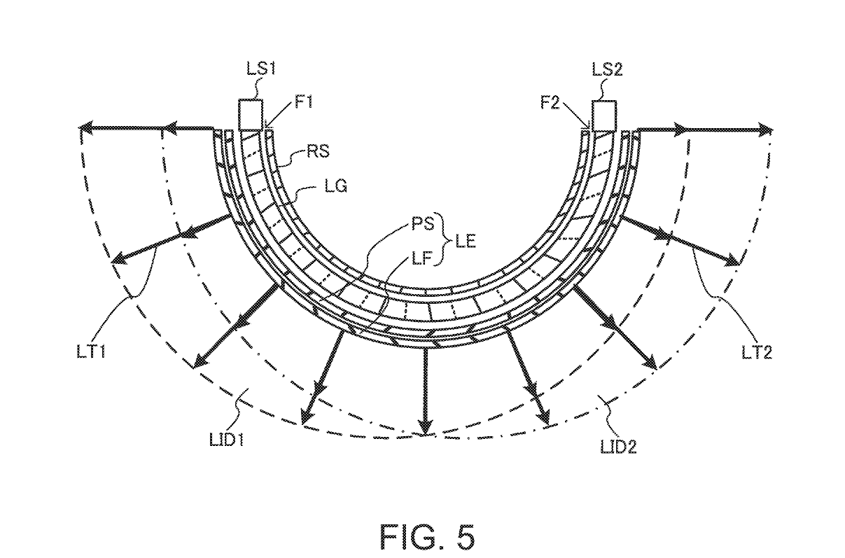

FIG. 5 illustrates an example of a detailed configuration of the light irradiating section EU according to this embodiment. The light irradiating section EU of the configuration example in FIG. 5 includes light source sections LS1 and LS2, a light guide LG, and an irradiation direction setting section LE, and further includes a reflection sheet RS. The irradiation direction setting section LE includes an optical sheet PS and a louver film LF. The light irradiating section EU according to this embodiment is not limited to the configuration shown in FIG. 5, and may employ such a variety of modifications that some of its components are omitted or replaced with different components, or different components may be added.

The light source sections LS1 and LS2 emit light, and have a light emitting element such as an LED (light emitting diode). The light source sections LS1 and LS2 emit infrared light (near infrared light which is near a visible light region), for example. That is, it is preferable that the light emitted by the light source sections LS1 and LS2 is light having a wavelength band which is efficiently reflected from an object such as a user's finger or a touch pen, or light having a wavelength band which is barely included in light in the environment which becomes ambient light. Specifically, the light is infrared light having a wavelength of about 850 nm which is light in a wavelength band with high reflectance to a surface of a human body, infrared light of about 950 nm which is light having a wavelength band which is barely included in light in the environment, or the like.

The light source light LS1 is formed on one end side of the light guide LG as indicated by F1 in FIG. 5. Further, the second light source section LS2 is formed on the other end side of the light guide LG as indicated by F2. Further, the light source section LS1 emits light to a light entering surface of one end side (F1) of the light guide LG to emit irradiation light LT1, so as to form (set) a first irradiation light intensity distribution LID1 in the detection area of the object. On the other hand, the light source section LS2 emits second light to a light entering surface of the other end side (F2) of the light guide LG to emit second irradiation light LT2, so as to form a second irradiation light intensity distribution LID2 which is different in intensity distribution from the first irradiation light intensity distribution LID1 in the detection area. In this way, the light irradiating section EU can emit irradiation light having different intensity distributions according to positions in the detection area RDET.

The light guide LG (light guiding member) guides the light emitted by the light source sections LS1 and LS2. For example, the light guide LG has a curve shape to guide the light from the light source sections LS1 and LS2 along a curved light guide path. Specifically, as shown in FIG. 5, the guide light LG is formed in an arc shape. In FIG. 5, the arc of the guide light LG has a central angle of 180°, but may have a central angle smaller than 180°. The light guide LG is formed by a transparent resin member such as an acryl resin or polycarbonate, or the like.

On at least one side of an outer circumferential side and an inner circumferential side of the light guide LG is performed a working process for adjusting a light emission efficiency of the light from the light guide LG. As the working process, for example, a variety of methods such as silk printing for printing reflection dots, stamping or injection molding for forming concaves and convexes, or groove forming may be employed.

The irradiation direction setting section LE realized by the prism sheet PS and the louver film LF is disposed on the outer circumferential side of the light guide LG, and receives the light emitted from the outer circumferential side (outer circumferential surface) of the light guide LG. Further, the irradiation direction setting section LE emits the irradiation light LT1 or LT2 of which irradiation direction is set in a direction toward the outer circumferential side of the light guide LG having the curved shape (arc shape) from the inner circumferential side thereof. That is, the direction of the light emitted from the outer circumferential side of the light guide LG is set (controlled) in the irradiation direction along a normal direction (radial direction) of the light guide LG, for example. Thus, in the direction toward the outer circumferential side from the inner circumferential side of the light guide LG, the irradiation light LT1 or LT2 is emitted in a radial shape.

Setting of the irradiation direction of the irradiation light LT1 or LT2 is realized by the prism sheet PS, the louver film LF or the like of the irradiation direction setting section LE. For example, the prism sheet PS raises up the direction of the light emitted at a low vision from the outer circumferential side of the light guide LG in the normal direction so that a peak of a light output characteristic is set in the normal direction. Further, the louver film LF blocks (cuts) the light (low vision light) in a direction other than the normal direction.

In this way, according to the light irradiating section EU of this embodiment, the light source section LS1 and LS2 are disposed in both ends of the light guide LG to alternately turn on the light source section LS1 or LS2, to thereby form two irradiation light intensity distributions. That is, it is possible to alternately form the irradiation light intensity distribution LID1 in which the intensity on one end side of the light guide LG increases and the irradiation light intensity distribution LID2 in which the intensity on the other end side of the light guide LG increases.

By forming the above-described irradiation light intensity distributions LID1 and LID2 and by receiving reflection light from the object obtained by the irradiation light having these intensity distributions, it is possible to detect the object with high accuracy, in which the influence of ambient light such as light of the environment is minimally suppressed. That is, it is possible to cancel out an infrared component included in the ambient light, and it is thus possible to minimally suppress a bad influence of the infrared component on detection of the object.

### 2. Method of Switching Command Process and Hovering Process

A method of switching the command process and the hovering process in the processing section 300 will be described. In the above-described optical detection system, it is possible to detect the position detection information on the object (specifically, for example, control electric current information which will be described later). Thus, it is possible to obtain the position information on the object as two dimensional coordinates of (X, Y), or the like, on the basis of the position detection information. However, in order to enable a specific application to be executed, it is necessary to appropriately switch the command process and the hovering process.

For example, in a character input application, the command process corresponds to a drawing command (actually, for drawing characters in a position on a screen corresponding to a position which is trailed by an object), and the hovering process corresponds to a cursor movement process (only for moving a cursor in a position on a screen corresponding to a drawing target position without drawing characters). If the switching between two processes is not appropriately performed, the character drawing is not performed.

If the drawing command is constantly executed, characters are written in a traversable manner, and thus, it is difficult to express a gap or the like between characters or a gap in characters. Further, even though only the hovering process (cursor movement process) is constantly performed, it is also difficult to draw characters only by recognizing a current drawing target position.

Further, a method may be considered for expressing the gap between characters and characters using a state (non-input state) where the command process and the hovering process are not performed (that is, switching between the command process and the non-input state), but since the hovering process is not performed in this case, it is difficult to recognize the current drawing target position. In the optical detection system according to this embodiment, since it is not necessary to be in contact with the target surface, differently from a touch panel, a minute difference may occur between a drawing position intended by a user and an actual drawing target position. This is caused by individual sense differences of users, for example. Accordingly, it can be said that a method of expressing the drawing target position using the hovering process is remarkably effective in this embodiment and the need to switch the command process and the hovering process is great.

Further, for example, in an application (for example, filer) of selecting and executing an icon on a screen, the command process corresponds to an icon execution command and the hovering process corresponds to an icon selection process. In order to appropriately select and execute an icon intended by the user, it is necessary to perform switching between the two processes.

However, it is difficult to perform switching between the command process and the hovering process only by obtaining the two dimensional coordinates of the object. Thus, the present applicant suggests a technique of obtaining three dimensional coordinates of the object using an appropriate method and of switching the command process and the hovering process according to Z coordinate information on the object.

Specifically, for example, as described with reference to FIG. 2, the plurality of (here, two) light receiving units is disposed in the Z axial direction, and the position in the Z axial direction is detected on the basis of the light reception results of the first light receiving unit PD1 and the second light receiving unit PD2. Hereinafter, a method of switching the processes on the basis of combination of the plurality of light reception results will be described as a first embodiment, and a method of using object movement information in addition to the combination of the light reception results will be described as a second embodiment.

### 2.1 First embodiment

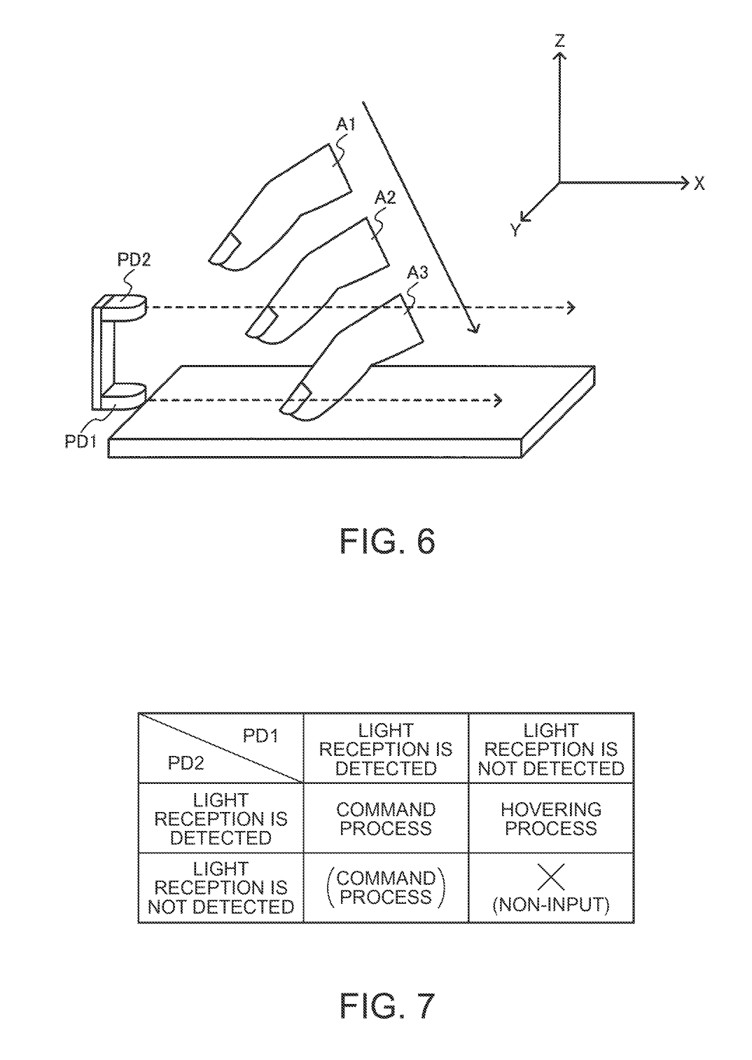

Firstly, the method of switching the processes on the basis of the combination of the plurality of light reception results will be described with reference to FIG. 6.

In a normal application of the optical detection system, when a determining operation is to be started, as indicated by an arrow in FIG. 6, an object (user's finger in an example of FIG. 6) is moved in a direction of A1→A2→A3. That is, it can be considered that as the object comes close to a target surface, the intention of the determining operation becomes strong. This can be naturally understood from the movement of the finger (pen or the like) when a character is to be drawn to the target surface.

Accordingly, it is natural that matching of the command process and the hovering process with respect to the combination of the light reception results of a light receiving unit 1 and a light receiving unit 2 is shown as in FIG. 7. As shown in FIG. 7, when the light receiving unit 1 and the light receiving unit 2 do not receive light (as indicated by A1 in FIG. 6), since the optical detection system is in a state where it does not detect the object, the process is not performed.

Further, when the light receiving unit 1 does not receive light and only the light receiving unit 2 receives light (as indicated by A2 in FIG. 6), the position information is detected, but since it is considered that the determining operation is being performed, the hovering process is performed. Thus, when both the light receiving unit 1 and the light receiving unit 2 receive light (as indicated by A3 in FIG. 6), it is determined that the determining operation is definitely performed, and then the command process is performed.

Further, when the light receiving unit 2 does not receive light and only the light receiving unit 1 receives light, even though this is a rare case in view of the configuration of the detection system, since the object is in a position close to the target surface, the command process is performed. Here, this is not limitative.

In this way, it is possible to appropriately and naturally switch the command process and the hovering process.

In the above-described embodiment, as shown in FIGS. 1A and 1B, the optical detection system includes the detecting section 200 which detects the position detection information on the object on the basis of the light receiving result of the reflection light obtained by reflecting the irradiation light from the object, and the processing section 300 which performs the process on the basis of the position detection information. Further, if it is detected that the Z coordinate range of the object from the target surface is in the first Z coordinate range, the processing section 300 performs the command process using the X coordinate information and the Y coordinate information on the object. Further, if it is detected that the Z coordinate range of the object is in the second Z coordinate range, the processing section 300 performs the hovering process using the X coordinate information and the Y coordinate information on the object.

Here, the X axis, Y axis and Z axis which are references of the respective coordinates of X, Y and Z are set as shown in FIGS. 1A and 1B. A target surface 20 is included in the XY plane, and a direction perpendicular to the XY plane, that is, the target surface is the Z axis.

Further, the first Z coordinate range and the second Z coordinate range are set as shown in FIG. 8, for example. The first Z coordinate range is in a range close to the target surface in the Z axial direction compared with the second Z coordinate range. As long as this condition is satisfied, each Z coordinate range can be freely set. For example, in an example of FIG. 8, the first Z coordinate range and the second Z coordinate range are neighboring to each other, but the embodiment is not limited thereto. For example, a third Z coordinate range may be set between the respective Z coordinate ranges as a buffer area. Further, a gap is not disposed between the first Z coordinate range and the target surface, but the embodiment is not limited thereto.

Further, here, the command process refers to at least one process among command determination and command execution. If a process corresponding to content of a certain command is performed, this means that the corresponding command is determined and then executed. In this embodiment, even if a command is only determined and its execution is performed after a time interval, this also means that the command process is performed. Here, the embodiment is not limited thereto, and thus, the command execution may be referred to as the command process.

Thus, in the optical detection system according to this embodiment (or optical detection apparatus including the optical detection system), it is possible to switch the command process (fixing function) and the hovering process (suspending function) using the Z coordinate information on the object. Accordingly, it is possible to smoothly perform the above-described drawing process, the icon selection and execution process or the like, and it is thus possible to realize an interface which is easy for a user to use.

Further, as shown in FIG. 2, the optical detection system includes the light irradiating section EU which emits the irradiation light and the light receiving section RU which includes the first light receiving unit and the second light receiving unit. The light irradiating section EU emits the irradiation light to the detection area in which the object is detected. Further, as shown in FIG. 2, the first light receiving unit PD1 receives the first reflection light obtained by reflecting the irradiation light from the object OB in the first detection area RDET1, and the second light receiving unit PD2 receives the second reflection light obtained by reflecting the irradiation light from the object OB in the second detection area RDET2. The detecting section 200 detects the X coordinate information and the Y coordinate information on the object in the first detection area RDET1, on the basis of the first position detection information which is the light reception result of the first reflection light. Similarly, the detecting section 200 detects the X coordinate information and the Y coordinate information on the object in the second detection area RDET2, on the basis of the second position detection information which is the light reception result of the second reflection light.

Accordingly, as shown in FIG. 2, the setting of the first Z coordinate range and the second Z coordinate range shown in FIG. 8 may be realized by arranging the plurality of (here, two) light receiving units in the Z axial direction. When the first light receiving unit PD1 receives the light, it can be determined that the object is in the Z coordinate range corresponding to the first light receiving unit PD1. Further, when the second light receiving unit PD2 receives the light, it can be determined that the object is in the Z coordinate range corresponding to the second light receiving unit PD2.

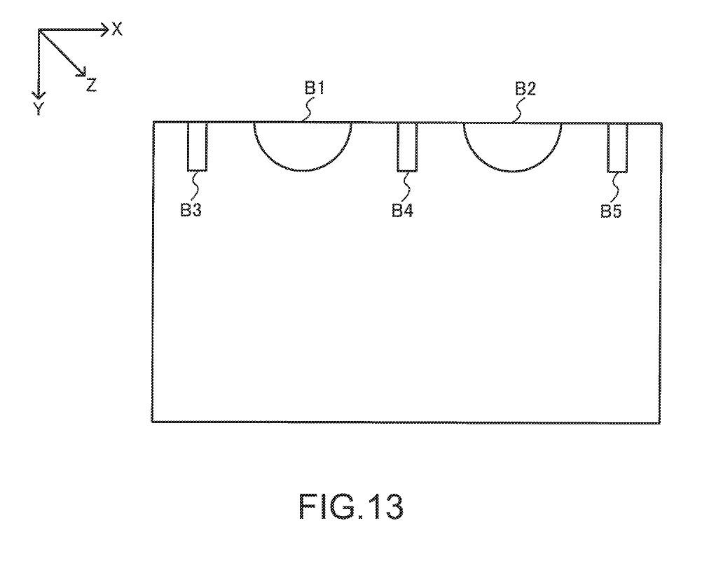

In this embodiment, the Z coordinate (Z coordinate range) of the object is detected by using the plurality of light receiving units, but the embodiment is not limited thereto. A different method capable of detecting the Z coordinate range of the object may be used, for example, as described later with reference to FIG. 13, the light receiving unit may be one. Alternatively, the Z coordinate may be detected by providing the plurality of light irradiating units.

Further, as shown in FIG. 2, the first light receiving unit PD1 may be disposed close to the target surface in the Z axial direction compared with the second light receiving unit PD2. In this case, the processing section 300 performs the command process on the basis of the X coordinate information and the Y coordinate information according to the light reception result of the first light receiving unit PD1 and performs the hovering process on the basis of the X coordinate information and the Y coordinate information according to the light reception result of the second light receiving unit PD2.

Thus, as shown in FIG. 2, it is possible to realize the first Z coordinate range by the first light receiving unit PD1 and to realize the second Z coordinate range by the second light receiving unit PD2. Thus, since the command process can be performed on the basis of the light reception of the light receiving unit 1 close to the target surface and the hovering process can be performed on the basis of the light reception of the light receiving unit 2 distant from the target surface, it is possible to switch the command process and the hovering process by an operation which is felt natural to a user.

Further, the processing section 300 may perform the hovering process after the light reception of the second light receiving unit PD2 is detected, and then may perform the command process after both the light receptions of the second light receiving unit PD2 and the first light receiving unit PD1 are confirmed.

Thus, it is possible to transit the hovering process to the command process using the natural operation of the user. As indicated by a solid arrow line in FIG. 6, when the determining operation is performed, it is considered that the object such as a finger is moved in a direction close to the target surface from a position distant from the target surface. Thus, the hovering process may be firstly performed by the light reception of the second light receiving unit PD2, and then the command process may by performed by both the light receptions of the first light receiving unit PD1 and the second light receiving unit PD2. As indicated by A3 in FIG. 6, since the configuration has such a limit that the light is received by both the first light receiving unit PD1 and the second light receiving unit PD2, it is difficult to consider a case where only the first light receiving unit PD1 receives the light and the second light receiving unit PD2 does not receive the light. However, a process in this case is performed arbitrarily as necessary, if any.

Further, the processing section 300 may perform at least one command process among drawing command determination and drawing command execution as the command process using the X coordinate information and the Y coordinate information on the object.

Thus, as described above, it is possible to realize the drawing process of characters or graphics by the optical detection system according to this embodiment. Specifically, for example, the optical detection system according to this embodiment may be applied to an apparatus such as an electronic black board.

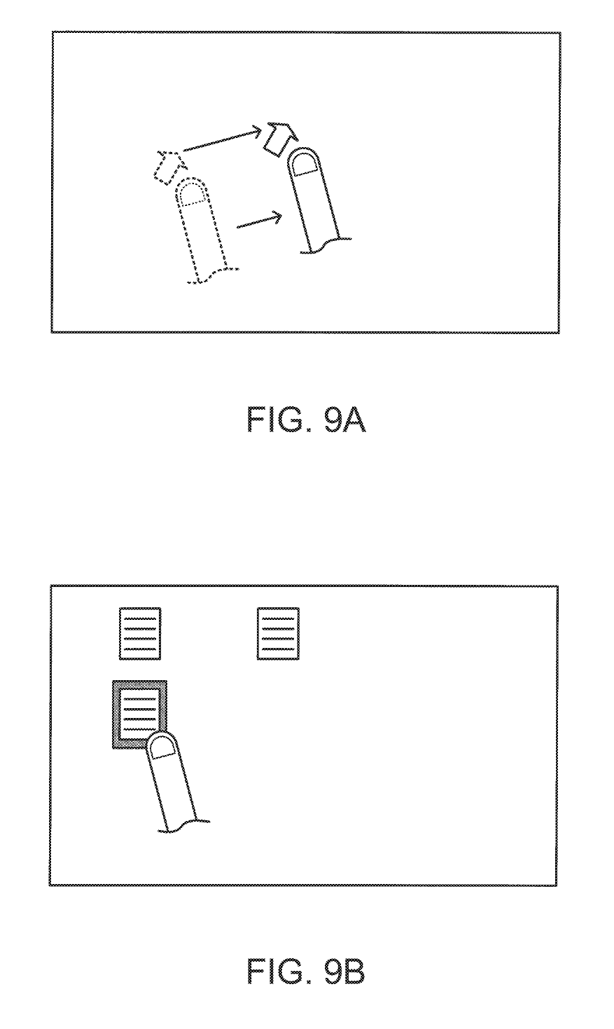

Further, the processing section 300 may perform a cursor movement process as shown in FIG. 9A or an icon selection process as shown in FIG. 9B as the hovering process, using the X coordinate information and the Y coordinate information on the object. The position of the moved cursor or the position of the selected icon may be a position on an image corresponding to the position of the object.

Thus, it is possible to perform the cursor movement process as the hovering process. Accordingly, for example, in the drawing process of characters or graphics, it is possible to specify the current drawing target position to the user. Further, it is possible to perform the icon selection process. Thus, for example, when an application such as a filer is used, it is possible to select the icon on the screen (in a state where its execution is not yet performed).

Further, the present embodiment relates to the optical detection system including the detecting section 200, the processing section 300 and the light receiving section RU. The detecting section 200 detects the object position detection information on the basis of the light reception result of the reflection light obtained by reflecting the irradiation light from the object. The processing section 300 performs the process on the basis of the position detection information. The light receiving section RU includes the first light receiving unit and the second light receiving unit, and the first light receiving unit is close to the target surface in the Z direction compared with the second light receiving unit. Further, the processing section 300 performs the command process on the basis of the X coordinate information and the Y coordinate information according to the light reception result of the first light receiving unit, and performs the hovering process on the basis of the X coordinate information and the Y coordinate information according to the light reception result of the second light receiving unit.

Thus, it is possible to switch the command process and the hovering process on the basis of the light reception results of the plurality of (here, two) light receiving units in the Z axial direction, regardless of the Z coordinate, the Z coordinate range or the like.

Further, the present embodiment relates to a program which causes a computer to function as the detecting section 200 and the processing section 300. The processing section 300 performs the command process using the X coordinate information and the Y coordinate information on the object, when it is detected that the Z coordinate range of the object from the target surface is in the first Z coordinate range. Further, the processing section 300 performs the hovering process using the X coordinate information and the Y coordinate information on the object, when it is detected that the Z coordinate range of the object from the target surface is in the second Z coordinate range.

Further, the present embodiment relates to a program which allows a computer to function as the detecting section 200 and the processing section 300. The detecting section 200 detects the position detection information on the object on the basis of the light reception result in the light receiving section RU, of the reflection light obtained by reflecting the irradiation light from the object. The processing section 300 performs the process on the basis of the position detection information. The light receiving section RU includes the first light receiving unit and the second light receiving unit, and the first light receiving unit is close to the target surface in the Z direction compared with the second light receiving unit. Further, the processing section 300 performs the command process on the basis of the X coordinate information and the Y coordinate information according to the light reception result of the first light receiving unit, and performs the hovering process on the basis of the X coordinate information and the Y coordinate information according to the light reception result of the second light receiving unit.

Thus, the present embodiment is not only realized by hardware, but may also be realized by software (program) installed in the optical detection system. Further, the program may be recorded on an information storage medium. Here, the information storage medium may include a variety of recording mediums which are capable of being read by the optical detection system, such as an optical disc such as a DVD or a CD, a magneto-optical disc, a hard disk (HDD), or a memory such as a non-volatile storing device or a RAM.

### 2.2 Second Embodiment

Next, a method of switching the processes on the basis of the object movement information in addition to the light reception result of the light receiving unit will be described.

As shown in FIG. 6, in this embodiment, the movement of the object in the start of the determining operation is the same as in the first embodiment.

In this embodiment, in a case where both the light receiving unit 1 and the light receiving unit 2 receive the light, and in a case where a time period from a time when the light receiving unit 2 receives the light to time when the light receiving unit 1 receives the light is smaller than a predetermined threshold, that is, in a case where the movement speed in the Z axial direction is greater than a predetermined threshold, the command process is performed. This corresponds to a case where the movement speed from A2 to A3 in FIG. 6 is great.

In this embodiment, the character drawing application is mainly described. That is, in the character drawing, when a series of sentences is written, it can be considered that the switching between the command process (a state where a pen tip is in touch with a sheet in the case of normal character drawing) and the hovering process (a state where a user suspends a pen above a sheet) is performed at a considerably high speed. Thus, in order to perform the command process, the conditions of the command process should be satisfied (both the light receiving unit 1 and the light receiving unit 2 should receive the light) in a predetermined time from the start of the hovering process.

Further, in a case where only the light receiving unit 1 receives the light and then the light receiving unit 2 receives the light after a predetermined time (and the light receiving unit 1 also continuously receives the light), although this case is difficult to consider in view of the configuration of the system, the command process may be performed. Here, this embodiment is not limited thereto.

In the above-described embodiment, the processing section 300 performs the command process using the X coordinate information and the Y coordinate information on the object, when the movement speed expressed by the movement speed information on the object in the Z axial direction is greater than the predetermined threshold. Specifically, in a case where the time period from the time when it is detected that the object is in the second Z coordinate range to the time when it is detected that the object is in the first Z coordinate range is smaller than the predetermined threshold, the processing section 300 may perform the command process using the X coordinate information and the Y coordinate information when it is detected that the object is in the first Z coordinate range.

Thus, when the movement speed of the object is great, that is, when the time necessary for the object to move from the second Z coordinate range to the first Z coordinate range is short, it is possible to perform the command process. Accordingly, by performing the natural operation in the application (particularly, the character drawing application as described above) execution, it is possible to switch to the command process. Further, by setting a strict switching condition, it is possible to prevent the command process from being unnecessarily performed, thereby making it possible to prevent a false operation or the like due to the unnecessary command process.

### 3. Method of Detecting Coordinate Information

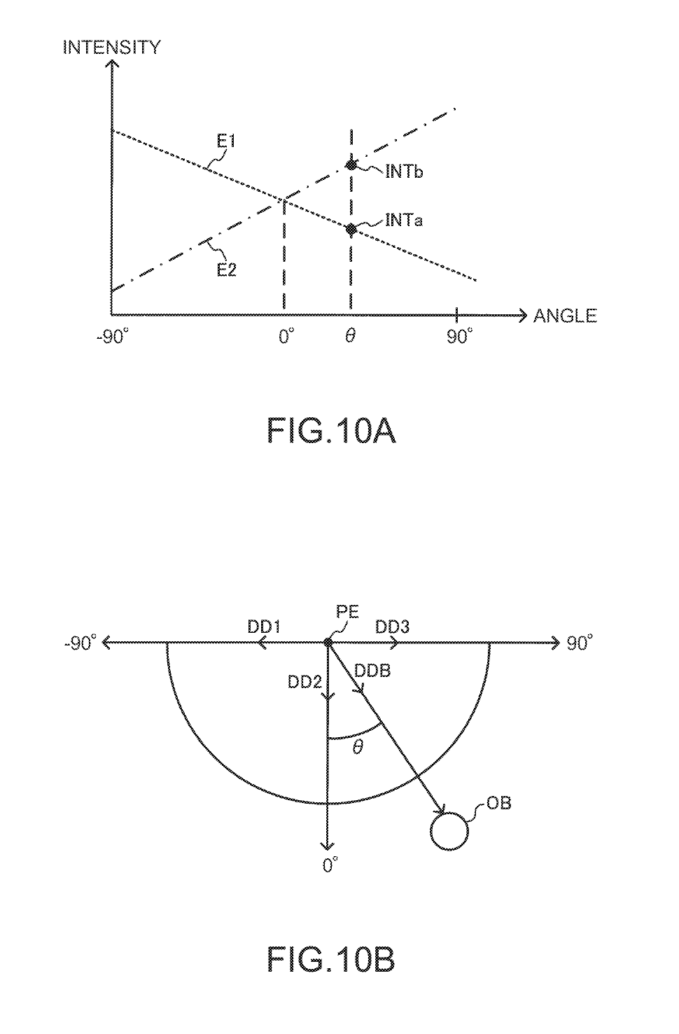

FIGS. 10A and 10B are diagrams illustrating a method of detecting coordinate information by means of the optical detection apparatus 100 including the optical detection system according to this embodiment.

E1 in FIG. 10A illustrates the relationship between an angle of the irradiation light LT1 in the irradiation direction and the intensity of the irradiation light LT1 at the angle thereof, in the irradiation light intensity distribution LID1 in FIG. 5. In E1 in FIG. 10A, the intensity becomes maximal when the irradiation direction is a DD1 direction (left direction) in FIG. 10B. On the other hand, when the irradiation direction is a DD3 direction (right direction), the intensity becomes minimal. An intermediate intensity is obtained in a DD2 direction. Specifically, with reference to an angle change from the DD1 direction to the DD3 direction, the intensity of the irradiation light monotonously decreases, for example, linearly changes. In FIG. 10B, an arc shaped center position of the light guide LG is disposed in an arrangement position PE of the light irradiating section EU.

Further, E2 in FIG. 10A illustrates the relationship between an angle of the irradiation light LT2 in the irradiation direction and the intensity of the irradiation light LT2 at the angle thereof, in the irradiation light intensity distribution LID2 in FIG. 5. In E2 in FIG. 10A, the intensity becomes maximal when the irradiation direction is the DD3 direction in FIG. 10B. On the other hand, when the irradiation direction is the DD1 direction, the intensity becomes minimal, and an intermediate intensity is obtained in the DD2 direction. Specifically, with reference to an angle change from the DD3 direction to the DD1 direction, the intensity of the irradiation light monotonously decreases, for example, linearly changes. In FIG. 10A, the relationship between the angle and the intensity in the irradiation direction is the linear relationship, but the present embodiment is not limited thereto, and may have a hyperbolic curve relationship or the like.

Further, as shown in FIG. 10B, it is assumed that the object OB is present in a direction DDB of an angle θ. Then, in a case where the irradiation light intensity distribution LID1 is formed as the light source section LS1 emits light (in the case of E1), the intensity in the position of the object OB which is present in the DDB direction (angle θ) becomes INTa, as shown in FIG. 10A. On the other hand, in a case where the irradiation light intensity distribution LID2 is formed as the light source section LS2 emits light (in the case of E2), the intensity in the position of the object OB which is present in the DDB direction becomes INTb.

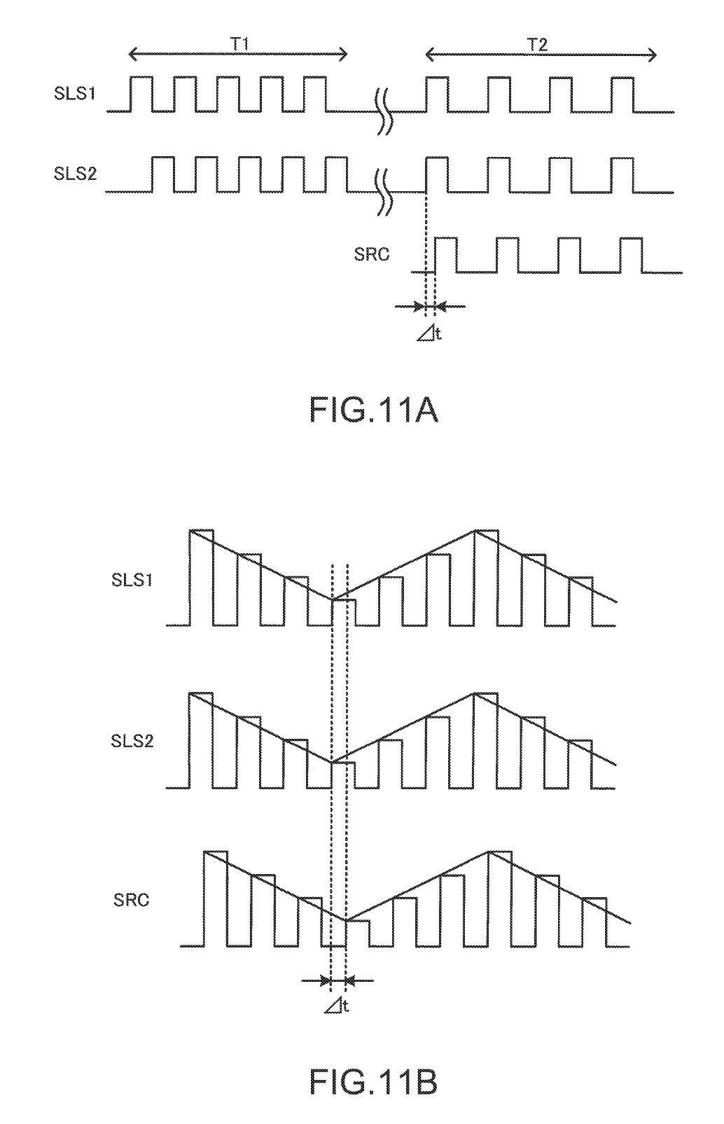

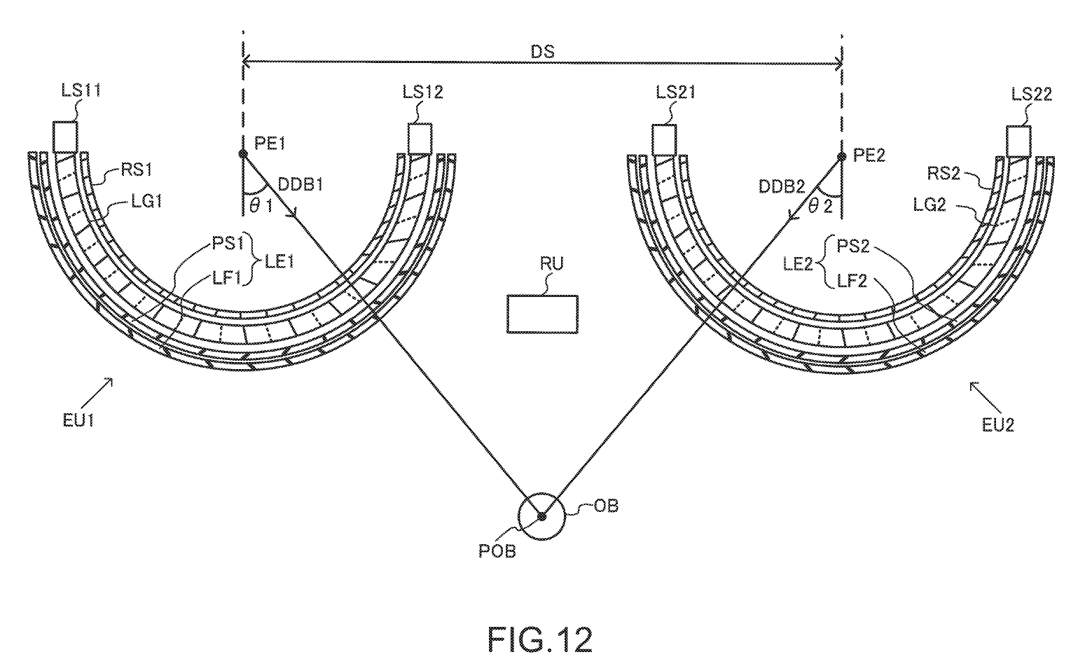

Accordingly, by calculating the relationship between the intensities INTa and INTb, it is possible to specify the DDB direction (angle θ) in which the object OB is positioned. Further, for example, by calculating the distance of the object OB from the arrangement position PE of the optical detection apparatus using the methods shown in FIGS. 11A and 11B, it is possible to specify the position of the object OB on the basis of the calculated distance and the DDB direction. Alternatively, as shown in FIG. 12 which will be described later, by installing two light irradiating units EU1 and EU2 as the irradiating section EU and by calculating the directions DDB1 (θ1) and DDB2 (θ2) of the object OB with regard to the respective light irradiating units EU1 and EU2, it is possible to specify the position of the object OB using the directions DDB1 and DDB2 and the distance DS between the irradiating units EU1 and EU2.

In order to obtain the relationship between the above-described intensities INTa and INTb, in this embodiment, the light receiving section RU receives the reflection light (first reflection light) of the object OB when the irradiation light intensity distribution LID1 is formed. If the detected light reception amount of the reflection light is represented as Ga, Ga corresponds to the intensity INTa. Further, the light receiving section RU receives the reflection light (second reflection light) of the object OB when the irradiation light intensity distribution LID2 is formed. If the detected light reception amount of the reflection light is represented as Gb, Gb corresponds to the intensity INTb. Accordingly, if the relationship between the detected light reception amounts Ga and Gb are calculated, the relationship between the intensities INTa and INTb is calculated, and thus, it is possible to calculate the DDB direction where the object OB is disposed.

For example, if a control amount (for example, electric current amount), a conversion coefficient and an emitted light amount in the light source section LS1 are respectively represented as Ia, k and Ea, and if a control amount (for example, electric current amount), a conversion coefficient and an emitted light amount in the light source section LS2 are respectively represented as Ib, k and Eb, the following expressions (1) and (2) are established.

Ea=k×Ia (1)

Eb=k×Ib (2)

Further, if an attenuation coefficient of the light (first light) from the light source section LS1 is represented as fa and the detected light reception amount of the reflection light (first reflection light) corresponding to the light is represented as Ga, and if an attenuation coefficient of the light (second light) from the light source section LS2 is represented as fb and the detected light reception amount of the reflection light (second reflection light) corresponding to the light is represented as Gb, the following expressions (3) and (4) are established.

Ga=fa×Ea=fa×k×Ia (3)

Gb=fb×Eb=fb×k×Ib (4)

Accordingly, the ratio between the detected light reception amounts Ga and Gb is expressed as the following expression (5).

Ga/Gb=(fa/fb)×(Ia/Ib) (5)

Here, Ga/Gb can be specified from the light reception result in the light receiving section RU, and Ia/Ib can be specified from the control amount of the light irradiating section EU. Further, the intensities INTa and INTb and the attenuation coefficients fa and fb in FIG. 10A have a unique relationship. For example, if the values of the attenuation coefficients fa and fb decrease and thus the attenuation amounts increase, it means that the intensities INTa and INTb decrease. On the other hand, if the values of the attenuation coefficients fa and fb increase and thus the attenuation amounts decrease, it means that the intensities INTa and INTb increase. Accordingly, as the ratio of the attenuation coefficients fa/fb is calculated from the expression (5), it is possible to calculate the direction, position and the like of the object.

More specifically, in order to fix one control amount Ia to Im and to obtain the ratio Ga/Gb of the detected light reception amounts as 1, the other control amount Ib is controlled. For example, the light source sections LS1 and LS2 are controlled to be alternately turned on in opposite phases, the waveforms of the detected light amounts are analyzed, and the other control amount Ib is then controlled so that the detected waveforms are not observed (Ga/Gb=1). Further, the ratio of the attenuation coefficients fa/fb is calculated from the other control amount Ib=Im×(fa/fb) at that time, to thereby calculate the direction and position of the object.

Further, as shown in the following expressions (6) and (7), the control may be performed so that Ga/Gb=1 and the sum of the control amounts Ia and Ib is constant.

Ga/Gb=1 (6)

Im=Ia+Ib (7)

If the expressions (6) and (7) are substituted into the expression (5), the following expression (8) is established.

Ga/Gb=1=(fa/fb)×(Ia/Ib)=(fa/fb)×{(Im−Ib)/Ib} (8)

Ib is expressed as the following expression (9) from the above expression (8).

Ib={fa/(fa+fb)}×Im (9)

Here, if fa/(fa+fb) is represented as α, the expression (9) is expressed as the following expression (10), and the ratio of the attenuation coefficients fa/fb is expressed as the following expression (11) using α.

Ib=α×Im (10)

fa/fb=α/(1-α) (11)

Accordingly, if the control is performed so that Ga/Gb=1 and the sum of Ia and Ib becomes the constant value Im, α is calculated from the Ib and Im at that time by the above expression (10). If the calculated α is substituted into the expression (11), the ratio of the attenuation coefficients fa/fb can be obtained. Thus, it is possible to calculate the direction, position and the like of the object. Further, as the control is performed so that Ga/Gb=1 and the sum of Ia and Ib becomes constant, it is possible to reduce the influence or the like of ambient light, thereby enhancing the detection accuracy.

Then, an example of a method of detecting the coordinate information of the object using the optical detection system according to this embodiment will be described. FIG. 11A is a signal waveform example for light emission control of the light source sections LS1 and LS2. A signal SLS1 is a light emission control signal of the light source section LS1 and a signal SLS2 is a light emission control signal of the light source section LS2, in which the signals SLS1 and SLS2 have opposite phases. Further, a signal SRC is a light receiving signal.

For example, the light source section LS1 is turned on (emits light) when the signal SLS1 is in a high level, and is turned off in a low level. Further, the light source section LS2 is turned on (emits light) when the signal SLS 2 is in a high level, and is turned off in a low level. Accordingly, during a first period T1 in FIG. 11A, the light source section LS1 and the light source section LS2 are alternately turned on. That is, in the period when the light source section LS1 is turned on, the light source section LS2 is turned off. Thus, the irradiation light intensity distribution LID1 as shown in FIG. 5 is formed. On the other hand, in the period when the light source section LS2 is turned on, the light source section LS1 is turned off. Thus, the irradiation light intensity distribution LID2 as shown in FIG. 5 is formed.

In this way, the detecting section 200 controls the light source sections LS1 and LS2 to be alternately turned on (emit light) during the first period T1. Further, in the first period T1, a direction is detected where the object is positioned when seen from the optical detection apparatus (light irradiating section). Specifically, for example, as expressed in the above expressions (6) and (7), the light emitting control is performed in the first period T1 such that Ga/Gb=1 and the sum of the control amounts Ia and Ib becomes constant. Further, as shown in FIG. 10B, the direction DDB where the object OB is disposed is calculated. For example, the ratio of the attenuation coefficients fa/fb is calculated from the expressions (10) and (11), and the direction DDB where the object OB is disposed is calculated by the method described in FIGS. 10A and 10B.

Further, in a second period T2 subsequent to the first period T1, a distance up to the object OB (distance in a direction along the DDB direction) is detected on the basis of the light reception result in the light receiving section RU. Further, the position of the object is detected on the basis of the detected distance and the DDB direction of the object OB. That is, in FIG. 10B, if the distance up to the object OB from the arrangement position PE of the optical detection apparatus and the direction DDB where the object OB is disposed, are calculated, it is possible to specify X and Y coordinate positions of the object OB. In this way, by calculating the distance from the time difference between the light emitting timing of the light source and the light receiving timing, and by combining the distance and the angle result, it is possible to specify the position of the object OB.

Specifically, in FIG. 11A, a time Δt to a timing when the light receiving signal SRC becomes active (timing when the reflection light is received) from the light emitting timings of the light source sections LS1 and LS2 by means of the light emitting control signals SLS1 and SLS2 is calculated. That is, the time Δt until light from the light source sections LS1 and LS2 is reflected from the object OB and is received by the light receiving section RU is detected. As the time Δt is detected, since the speed of light is already known, it is possible to detect the distance up to the object OB. That is, by measuring a difference width (time) in a light arrival time and by considering the light speed, the distance is calculated.

Since the light speed is considerably fast, it is difficult to detect the time Δt by calculating a simple difference only using an electric signal. In order to solve such a problem, it is preferable to modulate the light emission control signal as shown in FIG. 11B. Here, FIG. 11B illustrates examples of signal waveforms in which light intensities (electric current amounts) are schematically expressed by amplitudes of the control signals SLS1 and SLS2.

Specifically, in FIG. 11B, the distance is detected by TOF (Time Of Flight) which is a known continuous wave modulation method. In the continuous wave modulation TOF method, continuous light of which the intensity is modulated by a continuous wave of a specific cycle is used. Then, the intensity-modulated light is emitted and the reflection light is received a plurality of times at a time interval shorter than the modulation cycle. Then, the waveform of the reflection light is demodulated and a phase difference between the irradiation light and the reflection light is calculated, to detect the distance. In FIG. 11B, only the light corresponding to one of the control signals SLS1 and SLS2 may be intensity-modulated. Further, waveforms modulated by a continuous triangular wave or sine wave may be employed, instead of clock waveforms as shown in FIG. 11B. Further, the distance may be detected by a pulse modulation TOF method in which pulse light is used as the continuously modulated light. Details of the distance detection method are disclosed in JP-A-2009-8537, for example.

FIG. 12 illustrates a modified example of the light irradiating section EU according to this embodiment. In FIG. 12, the first light irradiating unit EU1 and the second light irradiating unit EU2 are provided as the light irradiating section EU. The first and second light irradiating units EU1 and EU2 are separated by a predetermined distance DS in a direction along a surface of the detection area RDET of the object OB. That is, the first and second light irradiating units EU1 and EU2 are separated by the distance DS along the X axial direction in FIGS. 1A and 1B.

The first light irradiating unit EU1 radially emits first irradiation light which is different in intensity according to an irradiation direction. The second light irradiating unit EU2 radially emits second irradiation light which is different in intensity according to an irradiation direction. The light receiving section RU receives first reflection light obtained by reflecting the first irradiation light from the first light irradiating unit EU1 from the object OB and second reflection light obtained by reflecting the second irradiation light from the second light irradiating unit EU2 from the object OB. Further, the detecting section 200 detects a position POB of the object OB on the basis of the light reception result in the light receiving section RU.

Specifically, the detecting section 200 detects the direction of the object OB for the first light irradiating unit EU1 as a first direction DDB1 (angle θ1), on the basis of the light reception result of the first reflection light. Further, the detecting section 200 detects the direction of the object OB for the second light irradiating unit EU2 as a second direction DDB2 (angle θ2), on the basis of the light reception result of the second reflection light. Further, the position POB of the object OB is calculated on the basis of the detected first and second directions DDB1 (θ1) and DDB2 (θ2) and the distance DS between the first and second light irradiating units EU1 and EU2.

According to the modified example in FIG. 12, as shown in FIGS. 11A and 11B, even though the distance between the optical detection apparatus and the object OB is not detected, it is possible to detect the position POB of the object OB.

In this case, the Z coordinate detection may be performed by providing the plurality of light receiving units in the Z axial direction as described above, but this embodiment is not limited thereto. For example, the light irradiating unit having the configuration as shown in FIG. 5 may be provided as B1 to B5 in FIG. 13.

B1 and B2 in FIG. 13 are used to calculate the X coordinate and the Y coordinate of the object (or angle θ), as described above. Further, the Z coordinate is detected by B3 to B5 which are disposed in a direction perpendicular to B1 and B2. Since B3 to B5 can detect the two dimensional coordinates (or angle) of the object in the plane (YZ plane in the example of FIG. 13) perpendicular to the XY plane, it is possible to specify the Z coordinate of the object.

In the above description, three irradiating units are used to detect the Z coordinate, but the number of the irradiating units is not limited thereto. The number of the irradiating units may be two or less, or may be four or more. Here, the irradiation light from the irradiating unit is emitted in a planar form while having a certain degree of range. That is, referring to the example of FIG. 13, the irradiation light from the irradiating units B3 to B5 is emitted only in a narrow range in the X axial direction. Thus, since the range in the X axial direction where the Z coordinate can be detected by one irradiating unit is limited a narrow range, it is preferable that the plurality of irradiating units are provided, as in the example of FIG. 13, so as to detect the Z coordinate in a wide range.

In the above description, the present embodiment is described in detail, but it will be understood to those skilled in the art that a variety of modifications can be made without substantially departing from the novelty and effects of the invention. These modifications should be construed to be included in the scope of the invention. For example, a term which is used in the description or drawings at least one time, together with a different term having broader or equivalent meaning, can be replaced with the different term in any location of the description or drawings. Further, the configurations and operations of the optical detection system, the display apparatus, the electronic device and the program are not limited to the above description of the present embodiment, and may be variously modified.

The entire disclosure of Japanese Patent Application No. 2010-204017, filed Sep. 13, 2010 is expressly incorporated by reference herein.

What is claimed is:

1. An optical detection system comprising:
a detecting section which detects position detection information on an object on the basis of a light reception result of reflection light obtained by reflecting irradiation light from the object; and
a processing section which performs a process on the basis of the position detection information,
wherein the processing section performs at least one command process among command determination and command execution using X coordinate information and Y coordinate information on the object, in a case where it is detected that a Z coordinate range of the object from a target surface is in a first Z coordinate range which is close to the target surface, and performs a hovering process which is a process for a hovering operation using the X coordinate information and Y coordinate information on the object, in a case where it is detected that the Z coordinate range of the object from the target surface is in a second Z coordinate range which is distant from the target surface compared with the first Z coordinate range.

2. The optical detection system according to claim 1,
wherein the processing section performs the command process using the X coordinate information and the Y coordinate information on the object, in a case where a movement speed which is expressed by Z directional movement speed information on the object is larger than a predetermined threshold.

3. The optical detection system according to claim 2,
wherein the processing section performs, in a case where a time period from a time when it is detected that the Z coordinate range of the object from the target surface is in the second Z coordinate range to time when it is detected that the Z coordinate range of the object from the target surface is in the first Z coordinate range is smaller than a predetermined threshold, the command process using the X coordinate information and the Y coordinate information on the object when it is detected that the Z coordinate range of the object from the target surface is in the first Z coordinate range.

4. The optical detection system according to claim 1, further comprising:
a light irradiating section which emits the irradiation light; and
a light receiving section which includes a first light receiving unit and a second light receiving unit,
wherein the light irradiating section irradiates a detection area which is an area in which the object is detected with the irradiation light,
wherein the first light receiving unit receives first reflection light obtained by reflecting the irradiation light from the object in a first detection area of the detection area,
wherein the second light receiving unit receives second reflection light obtained by reflecting the irradiation light from the object in a second detection area of the detection area, and
wherein the detecting section obtains the X coordinate information and the Y coordinate information on the object in the first detection area on the basis of first position detection information which is a light reception result of the first reflection light, and obtains the X coordinate information and the Y coordinate information on the object in the second detection area on the basis of second position detection information which is a light reception result of the second reflection light.

5. The optical detection system according to claim 4,
wherein the first light receiving unit is disposed in a position close to the target surface in the Z direction compared with the second light receiving unit, and
wherein the processing section performs the command process on the basis of the X coordinate information and the Y coordinate information of the detecting section according to the light reception result of the first light receiving unit, and performs the hovering process on the basis of the X coordinate information and the Y coordinate information of the detecting section according to the light reception result of the second light receiving unit.

6. The optical detection system according to claim 4,
wherein the processing section performs the hovering process in a case where the light reception of the second light receiving unit is detected, and then performs the command process in a case where the light reception of both of the second light receiving unit and the first light receiving unit is detected.

7. The optical detection system according to claim 1,
wherein the processing section performs, as the command process, at least one process among drawing command determination and drawing command execution on the basis of the X coordinate information and the Y coordinate information on the object.

8. The optical detection system according to claim 1,
wherein the processing section performs, as the hovering process, a process of moving a cursor to a screen position corresponding to the position of the object using the X coordinate information and the Y coordinate information on the object.

9. The optical detection system according to claim 1,
wherein the processing section performs, as the hovering process, a process of selecting an icon at a screen position corresponding to the position of the object using the X coordinate information and the Y coordinate information on the object.

10. An optical detection system comprising:
a detecting section which detects position detection information on an object on the basis of a light reception result of reflection light obtained by reflecting irradiation light from the object;
a processing section which performs a process on the basis of the position detection information; and
a light receiving section which includes a first light receiving unit and a second light receiving unit,
wherein the first light receiving unit is disposed in a position close to the target surface in the Z direction compared with the second light receiving unit, and
wherein the processing section performs the command process on the basis of the X coordinate information and the Y coordinate information of the detecting section according to the light reception result of the first light receiving unit, and performs the hovering process on the basis of the X coordinate information and the Y coordinate information of the detecting section according to the light reception result of the second light receiving unit.

11. A program which causes a computer to execute functions comprising:
a detecting section which detects position detection information on an object on the basis of a light reception result of reflection light obtained by reflecting irradiation light from the object; and
a processing section which performs a process on the basis of the position detection information,
wherein the processing section performs at least one command process among command determination and command execution using X coordinate information and Y coordinate information on the object, in a case where it is detected that a Z coordinate range of the object from a target surface is in a first Z coordinate range which is close to the target surface, and performs a hovering process which is a process for a hovering operation using the X coordinate information and Y coordinate information on the object, in a case where it is detected that the Z coordinate range of the object from the target surface is in a second Z coordinate range which is distant from the target surface compared with the first Z coordinate range.

12. A program which causes a computer to execute functions comprising:
a detecting section which detects position detection information on an object on the basis of a light reception result, in a light receiving section, of reflection light obtained by reflecting irradiation light from the object; and
a processing section which performs a process on the basis of the position detection information,
wherein the light receiving section includes a first light receiving unit and a second light receiving unit, and the first light receiving unit is disposed in a position close to the target surface in the Z direction compared with the second light receiving unit, and
wherein the processing section performs the command process on the basis of the X coordinate information and the Y coordinate information of the detecting section according to the light reception result of the first light receiving unit, and performs the hovering process on the basis of the X coordinate information and the Y coordinate information of the detecting section according to the light reception result of the second light receiving unit.
